(19) United States
(12) Patent Application Publication
(10) Pub. No.: US 2001/0032116 A1
(43) Pub. Date: Oct. 18, 2001

(54) System and method for providing information on market pricing

(76) Inventor: Geoffrey Hyatt, Boston, MA (US)

Correspondence Address: FOLEY, HOAG & ELIOT, LLP, PATENT GROUP, ONE POST OFFICE SQUARE, BOSTON, MA, 02109, US

(21) Appl. No.: 09/781,805

(22) Filed: Feb. 12, 2001

Related U.S. Application Data
(60) Provisional application No. 60/181,949, filed on Feb. 11, 2000.

(51) Int. Cl. G06F 7/00; G06F 17/30; G06F 17/60

(52) U.S. Cl. 705/10; 707/1

(57) ABSTRACT

Methods and systems for generating and providing information representative of market pricing for products and services, and in particular to systems and methods that provide buyers and sellers information representative of the current market value for a product, including a new and used product.

### FIELD OF THE INVENTION

This invention relates to methods and systems for generating and providing information representative of market pricing for products and services, and in particular to systems and methods that provide buyers and sellers information representative of the current market value for a product, including a new and used product.

### BACKGROUND OF THE INVENTION

Today the Internet has provided an enormous selection of on-line auctions, electronic store fronts, and other services and mechanisms that allow users to quickly and easily develop markets and exchanges for products and services. One of the most successful Internet models has been the electronic auction model wherein sellers can offer a product for auction, and buyers can submit bids for purchasing the offered product. Although Internet auction global sites have been phenomenally successful as a form of electronic commerce, these sites do raise new issues about the efficiency of an electronic marketplace that allows anyone to sell any type of good. For example, a market place is deemed most efficient when the buyers and sellers have an accurate sense of the appropriate pricing for a particular product. However, acquiring such information for the Internet auction space is somewhat difficult in that Internet auctions allow any buyer to sell any type of product in any condition to the public. This enormous diversity of products makes it extremely difficult for the casual buyer to make intelligent bids for products. Accordingly, unless a buyers and sellers is a fairly sophisticated purchaser of the products or services they are trying to buy from the auction site, the buyers and sellers is faced with the dilemma of being offered products which the buyers and sellers may desire but being offered those products at a price that the buyers and sellers has no meaningful, or objective, way to evaluate.

Accordingly, there is a need for a system or a method that can provide to a conventional buyers and sellers information that is representative of market pricing information for a wide variety of goods and services.

### SUMMARY OF THE INVENTION

The systems and methods described herein include a system for generating current market value pricing for products, and for delivering this market pricing is formation to buyers and sellers for use by the buyers and sellers as they purchase goods in real time.

More specifically, in one embodiment, the systems described herein include online databases of actual transaction prices generated, for example, by monitoring actual transactions that occur on-line, as well as reviewing price guide lists, and contacting traditional brick and mortar stores to collect from market participants, such as sales agents, information representative of actual transaction prices for certain goods and services. In one embodiment, the database includes information representative of the transaction pricing and information representative of the type of good that was associated with this transaction processing. For example, in those applications wherein the database is generating market pricing information for particular goods, the online database can include information representative of the type of good being sold and the transaction price associated with the sale of that good. The indexing process may process a description of the purchased good to associate that purchased good with a preexisting, or dynamically created, template that stores information about that product in a structured form. Other transactions identified by the indexing process as being associated with the same product template will therefore provide additional information as to actual transaction prices for the sale of goods associated with the product template. Optionally formulas may be employed for extrapolating or interpolating the data, thereby extending the collective data to cover more products. For example, one formula may identify a dollar value to depreciate a car for every 1,000 miles on that car above 50,000 miles.

The information collected within the online database may be offered to buyers and sellers through a website wherein the webserver is connected through a gateway program to the database of information, allowing buyers and sellers online access to the current market values for the products contained within the database. In a further optional practice, the webserver may be accessed through a wireless device such as a Palm Pilot™ or other device, thereby allowing a buyers and sellers access to market pricing information at the point of purchase.

### BRIEF DESCRIPTION OF THE DRAWINGS

The foregoing and other objects and advantages of the invention will be appreciated more fully from the following further description thereof, with reference to the accompanying drawings wherein;

FIG. 1 depicts schematically the structure of a system according to the invention that employs a computer network for providing market pricing information to a buyer or seller.

FIG. 2 depicts in more detail the structure of a system for providing market pricing information to a buyer or seller;

FIG. 3 depicts one embodiment or user interface provided by the webserver depicted in FIG. 2 for allowing a buyer or seller to access market pricing information through an online website.

### DESCRIPTION OF THE ILLUSTRATED EMBODIMENTS

To provide an overall understanding of the invention, certain illustrative embodiments will now be described, including a system that provides market pricing information to a buyer or seller. However, it will be understood by one of ordinary skill in the art that the systems and methods described herein can be adapted and modified for other suitable applications and that such other additions and modifications will not depart from the scope hereof.

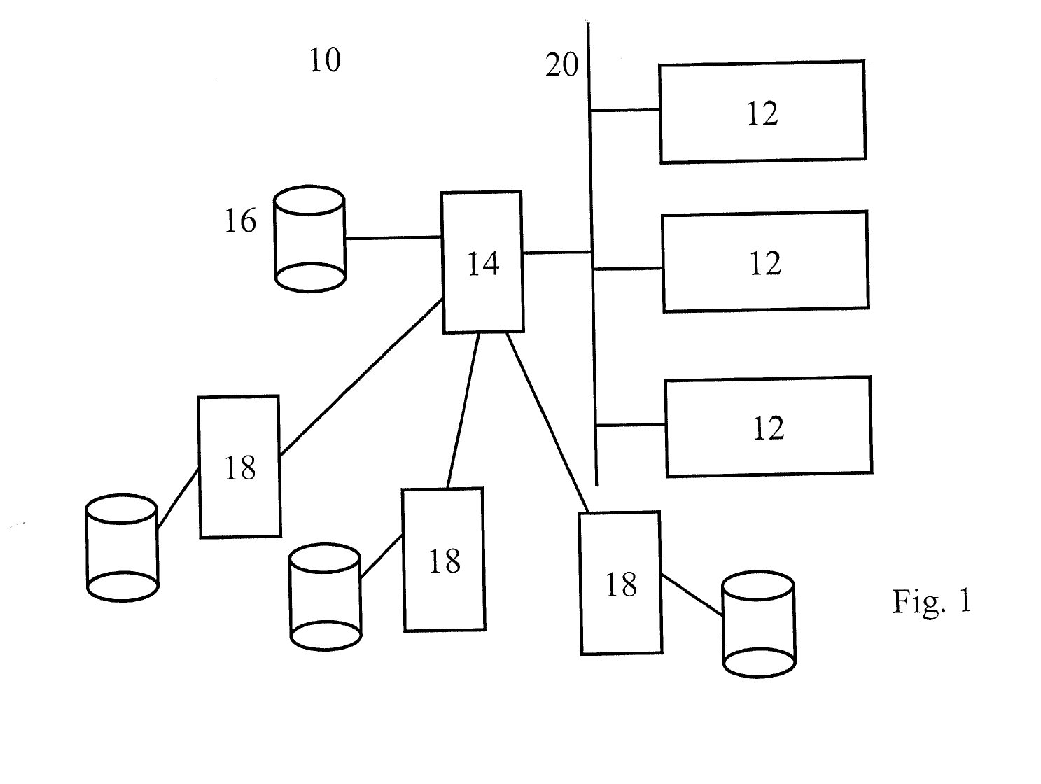

FIG. 1 depicts one embodiment of a system 10 according to the invention for providing buyers and sellers with market pricing information. Specifically, FIG. 1 illustrates a system 10 wherein a plurality of subscriber systems 12 connect through a network 20 to the server 14 or server which may be replicated in many locations. The server 14 connects to a proprietary database 16 maintained by the server 14. The database 16 is created by standard processes 15 from information in database 17 optionally by direct secure lines, from a plurality of other sites 18, such as online auction sites. The elements of the system 10 can include commercially available systems that have been arranged and modified to act as a system according to the invention, which allows a subscriber to collect market pricing information. The system 10 of FIG. 1 employs the network 20 to allow a buyer or seller at a remote client, the subscriber systems 12, to access a central server, the depicted central server 14, and to employ the services provided by that server 14.

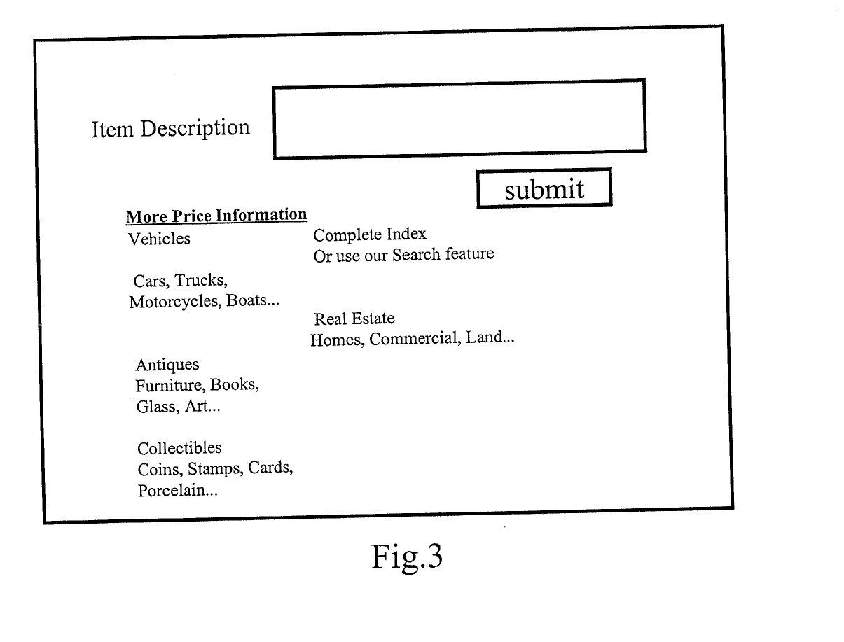

For example, the server 14 may present the subscriber with public or private password protected set of HTML pages that acts as a user interface. One such interface is depicted in FIG. 3. This user interface may present to the subscriber a set of controls for performing a search of the database 16, that contains market pricing information on a wide variety of goods. For example, the user interface may provide to the subscriber a window for entering a search phrase and a control, typically a button on a web page, that directs the system to search the contents of database 16 for entries that correspond with the entered search phrase.

Turning now to the elements that compose the system 10 depicted in FIG. 1, it can be seen the system 10 includes a network based system that includes a plurality of client systems 12 that connect through a network 20, such as the Internet IP network, or any suitable network to a server system, such as the server system 14 depicted in FIG. 1. The server 14 may connect over dedicated channels, over the Internet, or by other suitable means to other nodes that may or may not be on the network 20.

For the depicted system 10, the client systems 12 may be any suitable computer system such as a PC workstation, a handheld computing device, a wireless communication device, or any other such device, equipped with a network client capable of accessing a network server and interacting with the server to exchange information with the server. In one embodiment, the network client is a web client, such as a web browser that can include the Netscape web browser, the Microsoft Internet Explorer web browser, the Lynx web browser, or a proprietary web browser, or web client that allows the user to exchange data with a web server, an ftp server, a gopher server, or some other type of network server. Optionally, the client and the server rely on an unsecured communication path, such as the Internet, for accessing services on the remote server. To add security to such a communication path, the client and the server can employ a security system, such as any of the conventional security systems that have been developed to provide to the remote user a secured channel for transmitting data over the Internet. One such system is the Netscape secured socket layer (SSL) security mechanism that provides to a remote user a trusted path between a conventional web browser program and a web server. Therefore, optionally and preferably, the client systems 12 and the server system 14 have built in 128 bit or 40 bit SSL capability and can establish an SSL communication channel between the clients 12 and the server 14. Other security systems can be employed, such as those described in Bruce Schneir, Applied Crytpography (Addison-Wesley 1996). Alternatively, the systems may employ, at least in part, secure communication paths for transferring information between the server and the client. For purpose of illustration however, the systems described herein, including the system 10 depicted in FIG. 1 will be understood to employ a public channel, such as an Internet connection through an ISP or any suitable connection, to connect the subscriber systems 12 and the server 14.

The server 14 may be supported by a commercially available server platform such as a Sun Sparc™ system running a version of the Unix operating system and running a server capable of connecting with, or exchanging data with, one of the subscriber systems 12. In the embodiment of FIG. 1, the server 14 includes a web server, such as the Apache web server or any suitable web server. The web server component of the server 14 acts to listen for requests from subscriber systems 12, and in response to such a request, resolves the request to identify a filename, script, or dynamically generated data that can be associated with that request and to return the identified data to the requesting subscriber system 12. The operation of the web server component of server 14 can be understood more fully from Laurie et al., Apache The Definitive Guide, O'Reilly Press (1997). The server 14 may also include components that extend its operation to accomplish the transactions described herein, and the architecture of the server 14 may vary according to the application. For example, the web server may have built in extensions, typically referred to as modules, to allow the server 14 to perform operations that facilitate the transactions desired by a buyers and sellers, or the server 14 may have access to a directory of executable files, each of which may be employed for performing the operations, or parts of the operations, that implement the services described herein. Thus it will be understood that the server 14 may include programming instructions that configure the work station hardware supporting the server 14 to act as a system according to the invention.

The server 14 may also couple to a database 16 that stores information representative of the market pricing information for any type of good for which the system 10 has been able to capture and process information. In one embodiment, the database 16 stores information representative of the current market price for goods, particularly used goods that have been sold through online auction sites, and other online market places. The market pricing information associated with these goods may include the information that was provided by the online site regarding the transaction as well as other information including online indexes and lists for prices, conventional lists for pricing such as buyers and sellers reports and other such lists, and from surveys of knowledgeable participants in commercial transactions for these goods, such as sales agents that deal daily in these goods. The depicted database 16 may comprise any suitable database system, including the commercially available MySQL database, and can be a local or distributed database system. The design and development of database systems suitable for use with the system 10, follow from principles known in the art, including those described in McGovern et al., A Guide To Sybase and SQL Server, Addison-Wesley (1993). The database 12 can be supported by any suitable persistent data memory, such as a hard disk drive, RAID system, tape drive system, floppy diskette, or any other suitable system. The system 10 depicted in FIG. 1 includes a database device 16 that is separate from the server station platform 14, however, it will be understood by those of ordinary skill in the art that in other embodiments the database device 16 can be integrated into the server 14.

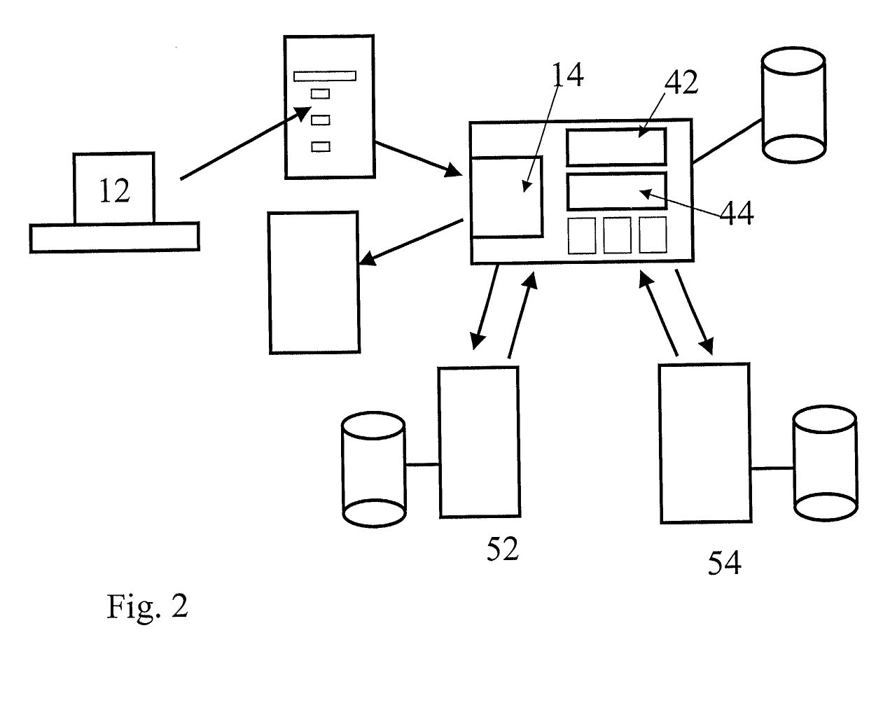

FIG. 2 provides a functional block diagram of one server 14 for generating and providing market price information and further depicts the data flow diagram of one example of a buyer or seller use of the server 14 to collect such information. Specifically, FIG. 2 depicts a data flow diagram wherein a buyer or seller 12 employs a user interface 32 to provide user input to the server 14. As can be seen from FIG. 2, the server 14 acts as middleware that coordinates the operations of an indexing mechanism 15 that is capable of monitoring activities at a plurality of online sources of market information, such as Internet auction sites, Usenet groups, online classified ads, and other sources of market pricing information and employing this information to create market price information for a plurality of different types of goods.

In one particular embodiment, the indexing mechanism 15 is capable of accessing these online sources of information, such as the depicted online sources 52 and 54 both of which can be representative of online auction services that provide to the public information regarding the transactions that occurred on that Internet auction site during a subsequent period of time, such as during the last two weeks, or an intermediate database 17 where this information has already been collected. The indexing mechanism 15 can process this information to identify the different types of products that were sold during that time period. For example, products sold on an online auction site are customarily described in a product description field that is a brief text field that describes the type of good and certain characteristics about that good. For example, the product description for an acoustic guitar being sold at an online auction house may include the manufacturer of the guitar, such as for example, Martin Guitar, the type of guitar such as for example a D-1 jumbo guitar, the year the guitar was manufactured, such as 1994, and the general condition of the guitar, such as good, fair, or poor. Other information such as whether the guitar comes with a hard shell case, or no case can also be presented in the product description. The indexing mechanism can collect this textual description of the product and process it to select from that description key words and phrases that the indexing mechanism 15 recognizes as descriptive of a product about which the indexing mechanism 15 is collecting information. To this end, the indexing mechanism 15 could have a product template data structure that has been defined by an editor, either human or automated, that comprises the plurality of fields, such as a product type field, in this case guitar, a product manufacturer field, in this case Martin, a product characteristic field that is relevant to this type of product such as the year of manufacture, the condition, whether or not it comes with a case and what type of case. The indexing mechanism 15 compares the product description provided by the online Internet site to determine whether or not a product template may be associated with that product description. If so, the product description may be further processed to select from that product description information that can be stored within the product template such as the manufacturer, year of manufacture, and general quality of the product. This information may be turned into an entry for storing within the database 16. As the indexing mechanism 15 continues to process other online auction sites, more information about the same type of product may be collected, and accordingly more entries for the same type of product may be stored within the database 16, thereby providing information representative of various prices of transactions which had occurred for a product during a relevant period of time. A pricing mechanism 44 can then go ahead and process data within the database 16 to generate for each product a reference price, or range of prices, which may be representative of a fair market value market pricing for that particular product. The pricing mechanism may be a set of executable files stored in a directory accessible to the web server 14, such as the cgi-bin directory. Such executable files may be scripts that implements the indexing and pricing functions. The scripts may be Perl V or php scripts, C language programs or any other suitable executable code for providing a process that can determine, in response to information provided by the subscriber, an access level to grant to the subscriber.

FIG. 3 depicts one example of a user interface that can be provided by the server 14 to a user that wishes to collect pricing information about a particular item. Specifically, FIG. 3 depicts that the user can enter a description of an item in a text field box that may be part HTML page generated by the server 14. The user can enter the product description, such as, for example, Martin Guitar 1964, and activate the submit control presented on the page. Using the HTML form protocol, the server 14 can receive the product description provided by the user and forward that description to a process that is capable of matching the product description to a product description that is known to the system 14. In particular, the product description provided by the user may be process at server 14 to match it to a product template that has been employed by the indexing process 42 for processing information about the pricing of transactions for similar goods.

The design and development of the systems described above follow from principles known in the art of computer programming, including those set forth in Wall et al., Programming Perl, O'Reilly & Associates (1996); and Johnson et al, Linux Application Development, Addison-Wesley (1998).

Although FIGS. 1 and 2 graphically depict the system 10 as functional block elements, it will be apparent to one of ordinary skill in the art that these elements can be realized as computer programs or portions of computer programs that are capable of running on the data processor platform 12 to thereby configure the data processor 12 as a system according to the invention.

The depicted database 16 and 17 can be any suitable database system, including the commercially available my SQL database, and can be a local or distributed database system. The design and development of suitable database systems are described in McGovern et al., A Guide To Sybase and SQL Server, Addison-Wesley (1993). The databases 16 and 17 can be supported by any suitable persistent data memory, such as a hard disk drive, RAID system, tape drive system, floppy diskette, or any other suitable system. The system depicted in FIG. 1 includes a database device 16 that is separate from the work station platform 14, however, it will be understood by those of ordinary skill in the art that in other embodiments the database device 16 can be integrated into the system 14.

Those skilled in the art will know or be able to ascertain using no more than routine experimentation, many equivalents to the embodiments and practices described herein. Accordingly, it will be understood that the invention is not to be limited to the embodiments disclosed herein, but is to be understood from the following claims, which are to be interpreted as broadly as allowed under the law.

I claim:

1. A system for providing pricing information, comprising:
indexing process for collecting data from a plurality of sources, the data being representative of market transactions, information about the item and price of the transaction, and for identifying and grouping market transaction information for similar items, and
a statistical pricing process for processing transaction information grouped market transactions, to thereby provide pricing information for transactions involving similar items.

2. The system of claim 1, further comprising a process for determining and displaying the change in price over time for the item.

3. The system of claim 2, wherein the change over time is given as a percentage of change is price or as an absolute price.

4. The system of claim 1 including a process for providing a list of transactions.

5. The system of claim 1, including a process for graphically displaying price points of transactions over time.

6. The system of claim 1, further comprising a process for allowing a user to specify attributes of products from a list of possibilities for such attributes.

7. A process for determining and presenting transactions selected for the group consisting of, most common, typical, standard deviation.

8. A process for showing summary fair market cost as acceptable.

9. A process for comparing the fair market value to current retail value, including retail value at other sites.

10. A process for determining information of fair market value for display on another site, wherein products of interest on that site have fair market value displayed.

11. A taxonomy developed for passing transaction information and for comparing transaction information across different sites.
